(19) United States
(12) Patent Application Publication
(10) Pub. No.: US 2002/0157647 A1
(43) Pub. Date: Oct. 31, 2002

(54) Pressure valve

(76) Inventors: Stanislaus Tomczak, Grossbottwar (DE); Kurt Frank, Schorndorf (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 09/959,486

(22) PCT Filed: Feb. 26, 2001
(86) PCT No.: PCT/DE01/00729

(30) Foreign Application Priority Data
Feb. 29, 2000 (DE) 1 00 09 592.5

(51) Int. Cl. F02M 1/00

(52) U.S. Cl. 123/458

(57) ABSTRACT

The invention relates to a pressure valve, in particular a pressure regulator, of a fuel supply system.

A contact terminal tab (20) is joined solidly and permanently to a housing part (4) of a pressure valve (2) with the aid of a joining material (24). A plug prong (20a) is formed onto the contact terminal tab (20). A cable leading to an electrical ground can easily be connected to the plug prong (20a).

### PRIOR ART

The invention is based on a pressure valve as generically defined by the preamble to claim 1.

German Patent Disclosure DE 197 12 155 A1 and International Patent WO 98/42973, which belongs to the same patent family, show an electrically conductive component, which is retained in an electrically insulating assembly. An electrically conductive connection is connected to the electrically conductive component. Via the electrically conductive connection, the electrically conductive component is connected to the electrical potential of an electrical conductor. The aforementioned published references show various exemplary embodiments. In one of the exemplary embodiments, a plug connection is formed onto the housing of a pressure regulator. To that end, a tab is stamped from the housing and the tab is bent outward, so that the tab can be connected to a plug coupling. In this version, it is a disadvantage that as a result of the stamping out of the tab, an opening is made in the housing, and thus the pressure regulator cannot be disposed just anywhere and in particular cannot be disposed in the region of the engine compartment of a motor vehicle. In another exemplary embodiment in the published references cited, a plug tab is soldered onto a retaining clamp. However, this version has the disadvantage that a special retaining clamp has to be used, and the expense for producing this retaining clamp is increased. Another disadvantage is that the electrical connection is not connected directly to the housing of the pressure regulator, which under some circumstances can cause poorer electrical contacting with the housing of the pressure valve. In other exemplary embodiments shown in these references, electrical contacting with the housing of the pressure regulator is brought about via resilient elements. However, these versions have the disadvantage that additional resilient elements are required, and that electrical transition resistances occur between the surfaces of the components used, especially a transition resistance between the housing of the pressure regulator and the resilient element where the electrical connection is connected.

German Published, Nonexamined Patent Application DE 195 26 524 A1 shows a pressure valve for controlling a pressure in a fuel supply system of a motor vehicle. The pressure valve has a fuel inlet connection and a continuing fuel-carrying connection. A tubular connection to the atmosphere or for the intake pressure of the internal combustion engine is secured to an upper housing part of the pressure valve. The pressure valve shown in DE 195 26 524 A1 is built into a fuel distributor tube. If the fuel distributor tube comprises electrically nonconductive material, then electrostatic charging of the pressure valve can occur.

### ADVANTAGES OF THE INVENTION

The pressure valve embodied according to the invention, having the definitive characteristics of claim 1, has the advantage over the prior art that precise positioning of the contact terminal tab is easily possible, and that the electrical contacting between the contact terminal tab and the pressure valve is assured in a simple and very safe, secure way.

By means of the provisions recited in the dependent claims, advantageous refinements of and improvements to the pressure valve defined by the main claim are possible.

If the gas connection is joined to the pressure valve via a joining material, and the joining material can be a meltable soldering medium, then the additional advantage is attained that in one operation, not only the connection between the gas connection and the housing part but also the connection between the contact terminal tab and the pressure valve can be made.

If the gas connection is embodied in the form of a tube, and if this tube protrudes through a through hole provided in the contact terminal tab, then the advantage is attained that in a very simple way, the connection between the gas connection and the housing part and the connection between the contact terminal tab and the pressure valve can be made. If the through hole entirely surrounds the gas connection embodied in the form of a tube, then the advantage is attained that the connection can be made especially simply without major effort, and excellent tightness and good mechanical stability are attainable.

The contact terminal tab secured in the region of the transition point offers the advantage that the housing part can be reinforced by the contact terminal tab in the region of the transition point, without requiring additional effort and expense to achieve this.

### DRAWING

Especially selected and especially advantageous exemplary embodiments of the invention are shown in simplified form in the drawing and explained in further detail in the ensuing description.

FIG. 1 shows an oblique view from the side of a first exemplary embodiment;

FIG. 2 shows a detail of the first exemplary embodiment in a sectional view;

FIG. 3 shows a detail of a modified exemplary embodiment; and

FIG. 4 shows a further exemplary embodiment, again obliquely from the side.

### DESCRIPTION OF THE EXEMPLARY EMBODIMENTS

The pressure valve embodied according to the invention serves for instance to control or regulate a pressure in a fuel supply system of an internal combustion engine. As this engine, an Otto engine can for instance be considered. The fuel is for instance gasoline or diesel fuel; since gasoline is especially readily flammable, it is proposed that the pressure valve be embodied according to the invention at least whenever the fuel is gasoline.

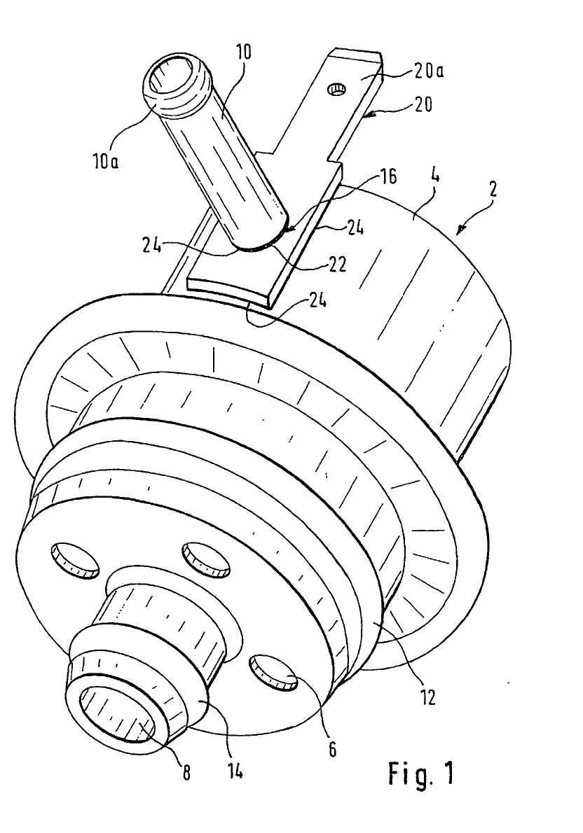

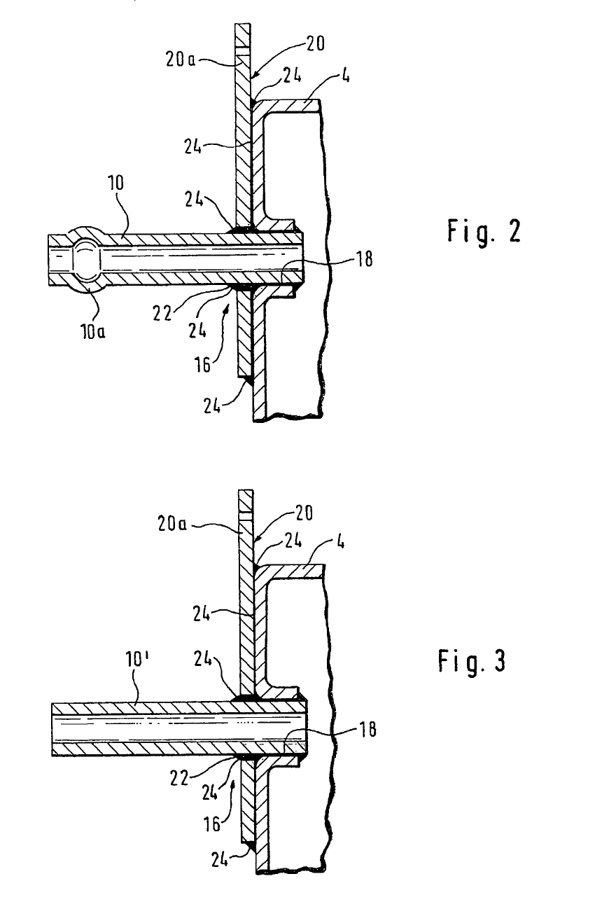

FIG. 1 shows a first, preferred, selected, and especially advantageous exemplary embodiment. FIG. 2 shows a detail of the exemplary embodiment. FIG. 2 shows a portion of a longitudinal section of the pressure valve.

In all the drawings, elements that are the same or function the same are identified by the same reference numerals. Unless otherwise noted or shown in the drawing, what is said and shown in conjunction with one of the figures applies to the other exemplary embodiments as well. Unless otherwise stated or implied by the explanations, the details of the various exemplary embodiments can be combined with one another.

FIG. 1 shows a pressure valve 2. The pressure valve 2 has a housing part 4. The housing part 4 can for instance be joined together from a plurality of individual parts stamped out of sheet metal. For instance, the housing part 4 is put together from two cup-shaped individual parts that are crimped to one another.

The pressure valve 2 has a fuel inlet connection 6, a continuing fuel-carrying connection 8, a gas connection 10, a first sealing ring 12, and a second sealing ring 14. The fuel inlet connection 6 is formed by holes stamped into the housing part 4. The continuing fuel-carrying connection 8 is located for instance on a connection tube inserted in pressure-tight fashion into the housing part 4. The fuel flows through the fuel inlet connection 6 into the pressure valve 2, and via the continuing fuel-carrying connection 8, the fuel flows out of the pressure valve 2 again.

The pressure valve 2 is mounted for instance on a fuel distributor tube comprising electrically nonconductive material. The fuel distributor tube has not been shown in the drawing, for the sake of simplicity. The pressure valve 2 is inserted for instance into a bore provided in the fuel distributor tube. In the fuel distributor tube, there is an inlet line leading to the bore and a continuing line leading away from the bore. The inlet line carries the fuel to the fuel inlet connection 6 of the pressure valve 2; the continuing line carries the fuel from the continuing fuel-carrying connection 8 of the pressure valve 2, for instance to a consumer or to a tank, not shown. The first sealing ring 12 seals off the bore, provided in the fuel distributor tube, and the inlet line from the outside. The second sealing ring 14 seals off the inlet line, leading to the fuel inlet 6 through the fuel distributor tube, from the continuing line that carries the fuel away from the continuing fuel-carrying connection 8.

The pressure valve 2 is built into the fuel distributor tube, for instance, as described and shown in German Published, Nonexamined Patent Application DE 195 26 524 A1. In the interior, the pressure valve can be embodied identically to what is described and shown for instance in German Patent Disclosure DE 197 12 155 A1 or International Patent WO 98/42973, or in German Reference DE 195 28 739 A1 and U.S. Pat. No. 5,509,390 or in DE 195 26 524 A1. To avoid unnecessary repetition, the possibilities shown in the aforementioned references for embodying the internal parts that can be built into the interior of the pressure valve 2 are referred to.

The pressure valve 2 can for instance be a pressure control valve or a pressure regulating valve or a differential pressure control valve or a differential pressure regulating valve. In the interior of the pressure valve 2, there is for instance a fuel chamber and a pressure control chamber. A group of diaphragms divides the pressure control chamber from the fuel chamber. The fuel inlet connection 6 leads into the fuel chamber. Via the gas connection 10, the pressure control chamber of the pressure valve 2 is connected to an intake line of the engine, for instance, via a line that is not shown in the drawing for the sake of simplicity. Via the gas connection 10, the negative pressure prevailing in the intake line can for instance be carried into the pressure control chamber provided in the pressure valve 2.

On a jacket face of the housing part 2, there is a transition point 16. At the transition point 16, the gas connection 10 discharges into the housing part 2 of the pressure valve 2. The transition point 16 between the gas connection 10 and the housing part 4 is embodied such that a tight connection is assured between the gas connection 10 and the housing part 4; that is, the interior of the pressure valve 2 is sealed off from its surroundings.

The gas connection 10 is for instance a tube segment comprising electrically conductive sheet metal. The housing part 4 is for instance a cup-shaped component stamped out of an electrically conductive metal sheet. For joining the gas connection 10 to the housing part 4, an opening 18 (FIG. 2) is provided in the housing part 4, on the cylindrical jacket face. The opening 18 is dimensioned such that the gas connection 10 can be inserted into the opening 18 with only slight play.

At the transition point 16, the gas connection 10 is solidly joined to the housing part 4, using a joining material 24. The connection is made for instance by soldering, especially hard soldering, or by welding. The meltable joining material 24 is preferably copper solder. The joining material 24 is therefore typically very highly electrically conductive.

In the region of the transition point 16, a contact terminal tab 20 is provided. The contact terminal tab 20 has a through hole 22. The through hole 22 is dimensioned such that the tubular gas connection 10 can be inserted through the through hole 22. Because the gas connection 10, on its end protruding from the housing part 4, has a bead 10a, the gas connection 10, when the pressure valve 2 is being put together, is inserted through the through hole 22 of the contact terminal tab 20 before being inserted into the opening 18 of the housing part 4.

After the contact terminal tab 20 has been slipped onto the gas connection 10 and after the gas connection 10 has been inserted into the through hole 22, the tubular gas connection 10, the contact terminal tab 20, and the housing part 4 are soldered to one another in the region of the transition point 16, using the joining material 24.

FIG. 3 shows a modified version. Here there is a modified gas connection 10′, instead of the gas connection 10. The gas connection 10′ has no bead. In this version, the contact terminal tab 20 can be slipped with its through hole 22 directly from outside onto the gas connection 10′.

The pressure-tight soldering of the gas connection 10, 10′ to the housing part 4 and the securing of the contact terminal tab 20 can be done in the same operation. For securing the contact terminal tab 20, no additional effort is therefore required. It is therefore possible, without requiring additional effort or expense, to create an excellent, permanently durable, electrically highly conductive and absolutely safe, secure connection between the contact terminal tab 20 and the gas connection 10, 10′, and between the contact terminal tab 20 and the housing part 4.

The end of the contact terminal tab 20 that protrudes from the transition point 16 projects past the housing part 4. This end of the contact terminal tab 20 is embodied in the form of a plug prong 20a. The plug prong 20a is dimensioned such that an electrical plug coupling that is typically used in motor vehicles can be slipped onto this end of the contact terminal tab 20. An electrical cable is located on the plug coupling. The cable connects to an electrical pole of the motor vehicle, and this electrical pole is preferably also the electrical ground of the motor vehicle. Slipping the plug coupling on makes it very easily possible to connect the cable electrically to the contact terminal tab 20. It is thus achieved that the pressure valve 2 or the housing part 4, and/or the gas connection 10, 10′, is electrically connected to a defined electrical potential even whenever the component in which the pressure valve 2 is installed comprises an electrically nonconductive material.

A contact terminal tab 20 is joined electrically securely and durably solidly to the gas connection 10, 10′ and the housing part 4 via the joining material 24. The joining material 24 forms a secure electrical connection between the contact terminal tab 20, housing part 4 and gas connection 10, 10′. Even if the gas connection 10, 10′ or the housing part 4 is of an electrically nonconductive material, nevertheless an electrical connection between the contact terminal tab 20 and the respective other component made of electrically conductive material, that is, the housing part 4 and the gas connection 10, 10′, is assured.

If the joining material 24 is made flowable by a suitable addition of heat, then it flows into the gaps between the components to be joined. Because the joining material 24 flows over a large region into the gaps between the components, that is, between the contact terminal tab 20, the housing part 4 and the gas connection 10, 10′, a mechanical reinforcement of the housing part 4 in the region of the opening 18 and additionally a mechanical reinforcement of the connection between the housing part 4 and the gas connection 10, 10′ is obtained as well with the aid of the contact terminal tab 20, without additional effort or expense.

As FIGS. 2 and 3 show, the gas connection 10, 10′ and the housing part 4 are joined together from separate components. In a modification of this, however, it is also possible to form the gas connection 10, 10′ and the housing part 4 integrally from the very outset. In this modification as well, it is advantageous to provide the contact terminal tab 20 at the transition point 16, where the housing part 4 merges with the gas connection 10, 10′, and to secure it with the joining material 24, because in this modification as well, an excellent electrical connection between the contact terminal tab 20 and the housing part 4, and between the contact terminal tab 20 and the pressure valve 2, is created at the transition point 16 in a simple way.

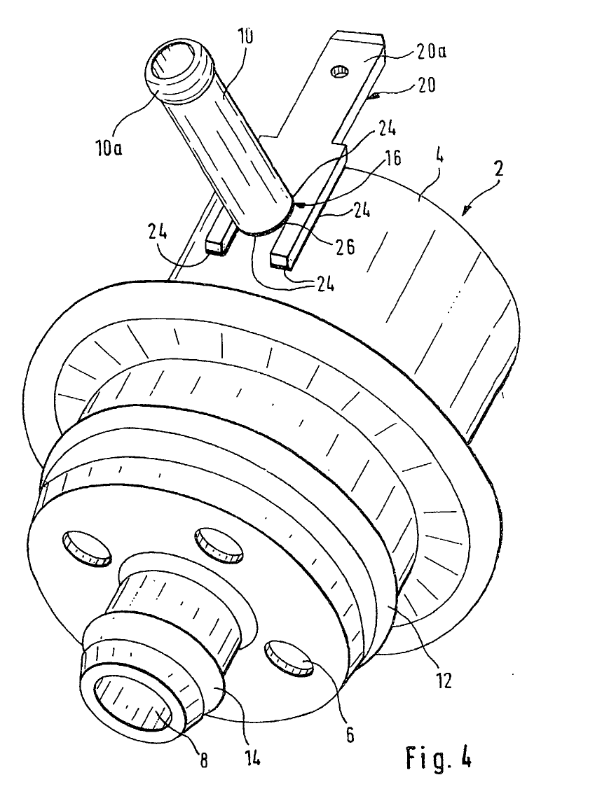

FIG. 4 shows a further, preferably selected and especially advantageous exemplary embodiment.

In the exemplary embodiment shown in FIG. 4, a countersunk channel 26 that extends through the full thickness of the contact terminal tab 20 is provided. The countersunk channel 26 is made instead of the through hole 22 shown in FIG. 1.

In the exemplary embodiment shown in FIG. 4, it is possible for the gas connection 10 to be inserted in advance into the opening 18 of the housing part 4 and for the contact terminal tab 20 to be slipped on after that, without having to take any account of the bead 10a of the gas connection 10.

1. A pressure valve, for controlling a pressure in a fuel supply system of a motor vehicle, having a housing part (4), having a fuel inlet connection (6), having a continuing fuel-carrying connection (8), and having a gas connection (10, 10′) communicating with the housing part (4) at a transition point (16), characterized in that an electrically conductive contact terminal tab (20) is provided, and the contact terminal tab (20) is secured to the pressure valve (2) at the transition point (16) with the aid of an electrically conductive joining material (24).

2. The pressure valve of claim 1, characterized in that the gas connection (10, 10′) communicates with the housing part (4) in pressure-tight fashion via the joining material (24).

3. The pressure valve of claim 1 or 2, characterized in that the contact terminal tab (20) has a through hole (22), and the gas connection (10, 10′) is embodied in the form of a tube, and the tube protrudes through the through hole (22).

4. The pressure valve of claim 1 or 2, characterized in that the contact terminal tab (20) has a countersunk channel (26), and the gas connection (10, 10′) is embodied in the form of a tube, and the tube protrudes through the countersunk channel (26).

5. The pressure valve of one of the foregoing claims, characterized in that the housing part (4) comprises an electrically conductive material.

6. The pressure valve of one of the foregoing claims, characterized in that the gas connection (10, 10′) comprises an electrically conductive material.

7. The pressure valve of one of the foregoing claims, characterized in that the joining material (24) is a soldering medium.

8. The pressure valve of one of the foregoing claims, characterized in that the contact terminal tab (20) acts as a plug prong (20a) of an electrical plug connection.

9. The pressure valve of one of the foregoing claims, characterized in that the pressure valve (2) is disposed on a fuel distributor tube comprising electrically nonconductive material.
